(19) United States
(12) Patent Application Publication
(10) Pub. No.: US 2008/0164109 A1
(43) Pub. Date: Jul. 10, 2008

(54) Composite brake disc

(75) Inventor: Hans-Michael Guether, Konigstein (DE)

Correspondence Address: Novak, Druce & Quigg LLP, 1300 I Street, N.W., Suite 1000, West Tower, WASHINGTON, DC, 20005, US

(73) Assignee: Audi AG, Ingolstadt (DE)

(21) Appl. No.: 12/000,502

(22) Filed: Dec. 13, 2007

(30) Foreign Application Priority Data
Dec. 6, 2006 (DE) 10 2006 058 714.6

(51) Int. Cl. F16D 65/12

(52) U.S. Cl. 188/218 XL

(57) ABSTRACT

Composite brake disk comprising a brake disk ring and a brake disk chamber having at least three fastening means for connection of the brake disk ring and brake disk chamber, the fastening means being blind rivets with a holding force in both directions parallel to the rivet axis, selected from cup rivets, tension pin rivets, pull-through rivets and removable pull-through rivets.

### CROSS-REFERENCE TO RELATED APPLICATIONS

This application claims priority from German Application No. 102006058714.6 filed Dec. 13, 2006, hereby incorporated by reference in its entirety.

The invention relates to a composite brake disk, comprising a brake disk ring and a brake disk chamber and fasteners for connection of the brake disk ring to the brake disk chamber in a composite brake disk.

### BACKGROUND OF THE INVENTION

Brakes disks are subject to high thermal and mechanical stresses. When the brake disk chamber and the brake disk ring are produced from materials with different coefficients of thermal expansion, or when a different heat distribution occurs on the brake disk, undesirable high stresses can form between the brake disk chamber and the brake disk ring. These stresses can lead to a wavy deformation of the brake disk ring.

To solve this problem, DE 43 32 951 A1 discloses supporting the brake disk ring on the brake disk chamber in a torque proof manner, but floating radially. On the one hand, sufficient transfer of torque to the wheel axis is ensured in this way, on the other hand the floating support makes it possible for both the brake disk ring and also the brake disk chamber to be able to expand independently of one another without the danger of deformations in the radial direction. In this way it is possible to produce the chamber with low component weight, for example from aluminum. To keep the brake disk ring on the brake disk chamber, in the latter a plurality of connecting elements in the form of radially projecting pins are poured. These pins are guided in radial holes on the inner periphery of the brake disk ring and enable relative movement of the two components in the radial direction. Since the pins project radially in all directions from the brake disk chamber, disassembly of the brake disk ring after assembly is no longer possible. Vibrations are also transmitted undamped by this structure from the brake disk ring via the brake disk chamber to the brake components and axle components, as a result of which noise can be generated.

Similar problems arise in the brake disk disclosed in DE 39 20 418 A1. With different thermal expansions, radially elastic movement between the brake disk chamber and the brake disk ring is possible there. For this reason, on the brake disk chamber radial grooves are formed which are movably engaged radially by crosspieces or projections attached to the brake disk ring. The brake disk ring is produced in a composite casting process in which the brake disk chamber is inserted into the casting mold for the brake disk ring, so that material of the brake disk ring travels into the grooves and thus the brake disk chamber and the crosspieces or projections of the brake disk ring intermesh like teeth. The radial mobility of the brake disk chamber and brake disk ring which is known from the prior art, however, promotes the occurrence of vibrations in the brake disk ring. This leads to deformations of the brake disk ring and thus to squeaking noises and brake judder, that is, to adverse effects on comfort.

In Published Patent Application DE 198 15 807 A1, a composite brake disk is described in which a brake disk ring is connected to the brake disk chamber by rivets or bolts. In this case, vibrations are damped by the mechanical separation of the brake disk chamber and brake disk ring and by the pretensioning of the components which is defined by the projection of a sleeve which surrounds the rivet or bolt, or by the placement of a highly damping material between the adjoining surfaces of the brake disk ring and the brake disk chamber.

Patent Specification DE 199 43 537 C1 discloses a construction in which a connecting element with a head and a sleeve-shaped shaft holds the brake disk ring and the brake disk chamber together. In the head there is a thread for holding a screw which penetrates the shaft of the connecting element, furthermore a slot which runs in a plane perpendicular to the axis of the sleeve dividing the head area in half, and the thread being provided only in the area between the slot and the head end which faces away from the shaft. With this construction there is a spring action which presses the brake disk ring and the brake disk chamber together.

### SUMMARY OF THE INVENTION

Against this background, the object of the invention is to find a fastening option for a composite brake disk with a brake disk chamber and a brake disk ring attached thereto, this fastening option tolerating the different thermal expansion behavior of the two components without adversely affecting the strength of the construction and without promoting the formation of vibrations, and wherein additional components are to be avoided.

To achieve this object, according to the invention, fastening of the brake disk ring on the brake disk chamber with blind rivets which are located parallel to the axis of rotation, in particular with pull-through rivets, is proposed. In this connection at least three of these blind rivets are necessary as fasteners in order to ensure sufficient stability. This construction does not require an additional spring-elastic element to the connecting means between the brake disk chamber and brake disk ring, it is to be made without play in the peripheral direction and yet allows radial play for compensation of the different thermal expansion behavior of the brake disk ring and brake disk chamber. Other preferred embodiments will become apparent from the dependent claims.

The axial elasticity of the blind rivets which can be specifically adjusted by the choice of the material used for this purpose and by the dimensioning of the blind rivet enables an appreciable reduction in the tendency to vibration. The potential of free radial motion between the friction ring and the brake disk chamber is enabled by elongated holes in at least one of the components brake disk ring and brake disk chamber, and preference is to be given to providing elongated holes in the brake disk chamber, especially when it is made of a metallic material. The elastic joining and the plurality of damping friction sites reduce the deformation of the brake disk and effects suppression of vibrations, which ultimately leads to improved comfort behavior.

By dividing the brake disk into two separate components, specifically the brake disk chamber and the friction ring, they can be produced from different materials. The reduction of deformations enables the use of ceramic materials for the brake disk ring.

### BRIEF DESCRIPTION OF THE DRAWINGS

The invention will be detailed below using the following drawings.

FIG. 1 shows a sectional view of one embodiment of a brake disk 1 with a fastening means 4 according to the invention for the brake disk ring 2 and the brake disk chamber 3,

FIG. 2 shows sections through different embodiments of the blind rivets 4 which can be used according to the invention, FIG. 2a showing a cup rivet 41, FIG. 2b showing a tension pin rivet 42, FIG. 2c showing a pull-through rivet 43 and FIG. 2d showing a removable pull-through rivet 44.

### DETAILED DESCRIPTION OF THE PREFERRED EMBODIMENTS OF THE INVENTION

According to one advantageous configuration of the invention, the brake disk chamber 3 has elongated holes 31 for the fasteners, the longest extension of the elongated holes 31 being parallel to a radius which extends through the middle of the elongated hole 31. Here it is preferable to select the length (greatest diameter) and the width (smallest diameter) of the elongated holes 31 such that the ratio of the length to the width is at least 2.0, especially preferably at least 2.5, and, in particular, at least 3.0. Preferably the brake disk chamber 3 is made of a metallic material.

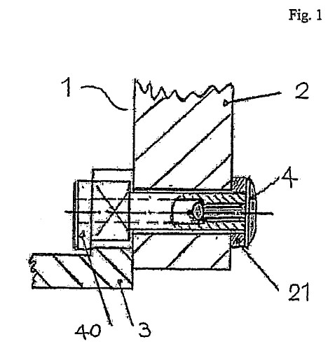

In particular, FIG. 1 shows a section through a brake disk 1 in which fastening of the brake disk ring 2 to the brake disk chamber 3 by means of a pull-through rivet 43 is illustrated. In the preferred form shown here, in the elongated hole 31 made in the brake disk chamber, there is a cylindrical rivet sleeve 40 which is not deformed when the pull-through rivet 43 is fixed and in this way ensures the radial mobility of the fastener in the elongated hole 31. There is a washer 21 between the rivet head and the brake disk ring 2. With the fasteners according to the invention the brake disk ring 2 is connected torque proof to the brake disk chamber 3 in the peripheral direction, but held radially floating. The forces acting in the axial direction between the brake disk chamber 3 and the brake disk ring 2 are captured by the elastic connection by the blind rivet 4.

Temperature-induced distortions of the brake disk ring 2 can be kept low by the potential of independent radial movement of the brake disk ring 2 and the brake disk chamber 3 relative to one another. This benefits vibration behavior.

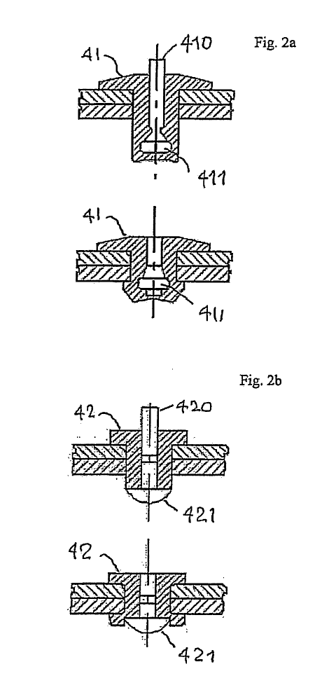

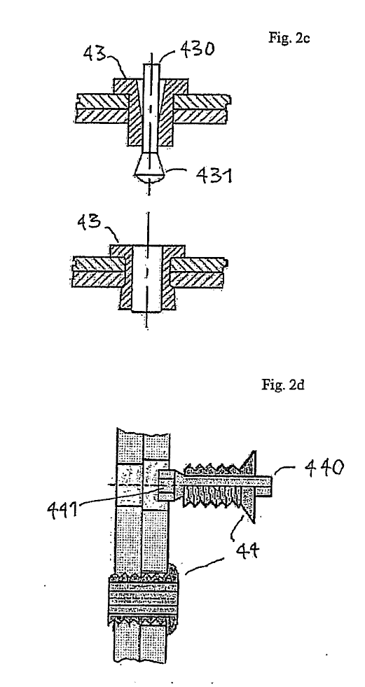

Instead of the pull-through rivet shown in the drawing of FIG. 1, the embodiments of blind rivets shown in FIGS. 2a, 2b and 2d analogously can be used as fasteners. It is also preferred in these fasteners that a sleeve 40 be used on the side facing away from the rivet head, especially when there is an elongated hole on this side.

The types of blind rivets shown in FIGS. 2a to 2d are characterized in that they are mounted without impact stress (in contrast to the “hammered” head rivets). The cup rivet 41 show in FIG. 2a (also called a sealed blind rivet) has the advantage of a closed shaft end; like all the blind rivets shown here, it is compressed by pulling a pin 410 on the projecting shaft end until the pin tears off, here at a predetermined breaking point intended for this purpose, the head 411 of the pin remaining in the rivet. In the tension pin rivet 42 (general form of a blind rivet according to DIN 7337 [German Industrial Standard 7337]), by pulling the pin 420 the rivet is compressed on the projecting shaft end until the pin 420 tears off at the predetermined breaking point intended for this purpose; the head 421 of the pin remains on and in the rivet. FIG. 2c shows a pull-through rivet 43; here the pin 430 is at least partially, or as shown, completely pulled through the rivet sleeve and compresses it in the process. There are both embodiments in which the pin can be pulled up to a narrow point in the sleeve and then tears off (as shown in FIG. 1) and also the embodiments shown in FIG. 2c in which the pin 430 is pulled entirely through the interior of the sleeve and compresses it in terms of a flow forming process with lateral extension. In a removable pull-through rivet 44 according to FIG. 2d, a pin 440, with a tip 441 made as an external hexagon, is pulled through the sleeve of the rivet and in the process forms an internal hexagon profile in the sleeve. After installation, this internally shaped rivet can be removed again with a hexagonal wrench.

The construction according to the invention with the fasteners intended for this purpose makes it possible to use different materials for the brake disk ring and the brake disk chamber with different coefficients of thermal expansion. In particular, it is thus possible to use ceramic materials or fiber-reinforced ceramic materials for the brake disk ring. These structures are especially well suited for carbon-ceramic brake disks, that is, carbon fiber-reinforced ceramic materials such as C/SiC, with a matrix containing essentially silicon carbide and unconverted silicon and residual carbon. The blind rivet provided according to the invention as fasteners easily yield a connection which can be highly loaded both in the peripheral direction and can be made without play, and also a connection with elastic axial play and the potential of fixing in spite of different expansion behavior upon heating. In the known prior art such a simple and economically favorable solution has not yet been described.

But the invention is not limited to the illustrated embodiment and the explained modifications; but rather it encompasses all embodiments defined by the claims.

### REFERENCE SYMBOL LIST

1 brake disk
2 brake disk ring
21 washer
3 brake disk chamber
31 elongated hole
4 fastener
40 sleeve
41 cup rivet
410 pin
411 head of the pin 410
42 tension pin rivet
420 pin
421 head of pin 420
43 pull-through rivet
430 pin
431 head of pin 430
44 removable pull-through rivet
440 pin
441 tip of the pin 440 with a hexagonal profile

1. A composite brake disk comprising a brake disk ring and a brake disk chamber having at least three fastening means for connection of the brake disk ring and brake disk chamber, the fastening means being blind rivets with a holding force in both directions parallel to the rivet axis, selected from cup rivets, tension pin rivets, pull-through rivets and removable pull-through rivets.

2. (canceled)

3. The composite brake disk according to claim 1, wherein the brake disk chamber has elongated holes for the fastening means, the longest extension of the elongated holes being parallel to the radius which extends through the middle of the elongated hole.

4. The composite brake disk according to claim 1, wherein the brake disk chamber is made of a metallic material.

5. The composite brake disk according to claim 1, wherein the brake disk ring is made of a ceramic material.

6. Composite brake disk according to claim 5, wherein the ceramic material contains reinforcing fibers.
